(19) United States
(12) Patent Application Publication
(10) Pub. No.: US 2012/0133937 A1
(43) Pub. Date: May 31, 2012

(54) IMAGING SYSTEM

(76) Inventors: Rainer Heintzmann, Jena (DE); Kai Wicker, Jena (DE)

(21) Appl. No.: 13/319,391

(22) PCT Filed: May 7, 2010
(86) PCT No.: PCT/GB2010/000924

§ 371 Date: Feb. 17, 2012

(30) Foreign Application Priority Data
May 8, 2009 (GB) 0907965.8

(51) Int. Cl. G01J 4/00

(52) U.S. Cl. 356/364

(57) ABSTRACT

A method of obtaining, in a single exposure, imaging information from an object (16) representative of more than two distinct illumination images, the method comprising the steps of generating first electromagnetic waves (14) at least some of which having spatially modulated polarisation; illuminating the object with the first electromagnetic waves; and capturing second electromagnetic waves (18) emanating from the object.

### FIELD

This invention relates to an imaging system. Embodiments relate to structured illumination microscopy. These may be applied, but by no means limited, to use with the imaging of dynamic biological processes.

### BACKGROUND

Microscopic imaging of dynamic biological specimens is a highly desirable tool in medical treatment and research. However, these specimens may be sized such that the features of interest are too small for the resolution of the optical system employed for viewing, and the thickness of the specimen may be such that background noise introduced by out-of-focus light in the system degrades the contrast and signal quality of the image produced.

It is known that both the spatial resolution of a microscope may be increased and the specimen may be optically sectioned by utilising structured illumination microscopy (SIM) [1, 2].

With known SIM, the specimen is illuminated with a light pattern of periodically, for example sinusoidally, modulated intensity. In order to provide optical sectioning, at least three illumination images are captured using different positions of the sinusoidal modulation in intensity. From these illumination images, one final image with the desired optical sectioning may be computed.

Modulating the illumination with such a sinusoidal intensity pattern also translates high-spatial-frequency information (corresponding to finer details in the specimen) into low-spatial-frequency information. Previously, the high-frequency information would have been lost (limited by the numerical aperture of the microscope). This may now be captured.

The three illumination images contain both optically sectioned and higher resolution information that may be extracted. For the n^{th} image Iₙ the relative pattern position corresponds to a phase of n2π/3, and the final image Iₙ can be calculating using the equation

I=\sqrt{(I₁−I₂)²+(I₂−I₃)²+(I₃−I₁)²}

or any of the other known methods (see [5,6] for a summary).

The final image obtained is both optically sectioned and of an enhanced resolution.

The above effect, may, in principle, be obtainable with two source images, however, more complex computational methods are required to extract the desired information, parts of which will have to be extrapolated.

Such is the nature of dynamic biological specimens, they may be moving around at speed. In systems such as the above, where two or more distinct images must be captured in order to obtain the necessary information for reconstruction of the final image, the specimen must appear stationary with respect to the time period taken to capture those images. Standard SIM is currently capable of a temporal resolution in the millisecond range.

A number of techniques have been developed for capturing the relevant imaging information in one exposure; for example by representing the different positions of intensity by different illumination colours [3]; and with a selective plane illumination microscope (SPIM) whereby only the section of interest is illuminated by a light sheet [4].

However, colour coded SIM is ill-suited for fluorescence microscopy where there are heavy technical requirements of ensuring the specimens are labelled such that they yield separate, distinguishable fluorescent response under each of the three colours of illumination to the same concentration.

SPIM is limited by the relatively broad width of the illuminating light sheet and therefore only has a sectioning capability of approximately 5 μm. Recent combinations with structured illumination yield improvements albeit with a requirement of an increased number of exposures. Thus the methods described herein can be applied and combined with SPIM accordingly.

There is, therefore, a need to provide the ability to acquire all the necessary imaging information for a SIM image reconstruction from a single exposure and which can capture sufficient imaging information efficiently.

### SUMMARY

According to a first aspect there is provided a method as defined in Claim 1 of the appended claims. Thus there is provided a method of obtaining, in a single exposure, imaging information from an object representative of more than two distinct illumination images, the method comprising the steps of generating first electromagnetic waves at least some of which having spatially modulated polarisation, illuminating the object with the first electromagnetic waves and capturing second electromagnetic waves emanating from the object.

According to a second aspect there is provided a method as defined in Claim 2 of the appended claims. Thus there is provided a method of obtaining, in a single exposure, imaging information from an object representative of at least two distinct illumination images, the method comprising the steps of generating first electromagnetic waves at least some of which having spatially modulated polarisation, illuminating the object with the first electromagnetic waves; and capturing second electromagnetic waves emanating from the object.

When a computer is used to extract the imaging information, the captured second electromagnetic waves may then be processed by the computer and imaging information extracted from the processed waves.

Several methods of producing the first electromagnetic waves at least some of which having a spatially modulated polarisation pattern may be employed. One method is generating incoherent light and filtering the incoherent light with a spatially varying polarising filter. Alternatively, the method may comprise generating a light source; splitting the light source into two light beams; altering the phase delay between the two light beams such that the beams have opposing circular polarisation; and re-combining the two light beams back together. The altering step may comprise passing each light beam through a separate λ/4 wave plate, one wave plate arranged to generate left-circular polarised light, the other arranged to generate right-circular polarised light. The light source may be a coherent light source.

Alternatively, the generating step may comprise generating light having a sinusoidal intensity pattern; linearly polarising the light at an angle of 45° with respect to the principal axis of a birefringent material; passing the light through the birefringent material to produce two separate beams and re-combining the two beams back together with a lateral shift. The birefringent material may be a calcite crystal.

Yet further alternatively, the generating step may comprise generating light having a sinusoidal intensity pattern; linearly polarising the light at an angle of 45°; passing the light through a polarising beam splitter to form two separate beams; introducing a lateral shift into one of the beams; and re-combining the two beams back together.

The capturing step may comprise splitting the light emanating from the object into at least two distinct beams; passing each beam through a polarisation analyser; and capturing the light in one exposure with a capture device.

The polarisation analysers may be positioned at n180°/x where x equals the number of distinct beams of light and n=1 to x.

The first electromagnetic waves may be in the visible spectrum, and at least some of the first electromagnetic waves may be monochromatic.

Alternatively, the first electromagnetic waves may be in the ultra-violet spectrum, infra-red spectrum, x-ray spectrum, or radio spectrum.

The spatially modulated polarisation of the first electromagnetic waves may vary periodically from 0° to 180°, aperidocially, quasi-periodically or rotationally. At least some of the first electromagnetic waves may have a spatially uniform polarisation distribution.

According to a third aspect there is provided a system for obtaining, in a single exposure, imaging information from an object representative of more than two distinct illumination images, the system comprising means arranged to generate first electromagnetic waves at least some of which having spatially modulated polarisation, means arranged to illuminate the object with the first electromagnetic waves and means arranged to capture second electromagnetic waves emanating from the object.

According to a fourth aspect there is provided a system for obtaining, in a single exposure, imaging information from an object representative of at least two distinct illumination images, the system comprising means arranged to generate first electromagnetic waves at least some of which having spatially modulated polarisation means arranged to illuminate the object with the first electromagnetic waves and means arranged to capture second electromagnetic waves emanating from the object.

With all the aspects, optional features are defined in the dependent claims.

### BRIEF DESCRIPTION OF THE DRAWINGS

Embodiments will now be described, by way of example only, and with reference to the drawings in which:

FIG. 1 illustrates an overview of the imaging system;

FIG. 2 illustrates a spatially modulated pattern of polarisation according to an embodiment of the imaging system;

FIG. 3 illustrates generation of first electromagnetic waves 14 by way of polarisation filtering;

FIG. 4 illustrates generation of first electromagnetic waves 14 by way of beam interference;

FIG. 5A illustrates generation of first electromagnetic waves 14 by way of birefringence;

FIG. 5B illustrates generation of first electromagnetic waves 14 by way of introducing an n+¼ A lateral shift into one of two beam paths;

FIG. 6 illustrates the resultant modulation of polarisation from the generation of FIG. 5;

FIG. 7 illustrates an embodiment of capturing means 20 comprising a beam splitter and polarisation analysers; and

FIG. 8 illustrates a practical realisation of FIGS. 4 and 7.

In the figures, like elements are indicated by like reference numerals throughout.

### DETAILED DESCRIPTION

### Overview

In overview, the polarisation properties of EM waves are used to capture, in a single exposure, imaging information from an object, representative of at least two single exposure illumination images, the illumination images each resulting from different illuminating sources. For example, the illuminating sources may comprise different intensity pattern positions or different colours of illumination as discussed in the background section above, or alternatively could comprise different polarisation patterns of illuminating light. The resultant information captured may then be processed and the information pertaining to an optically sectioned image may be extracted. Furthermore, as only one exposure is required to optically section, a very high frame-rate (or, depending on the recording device, bursts of one or more frames, for example where the exposure time is defined by a laser pulse) can be achieved facilitating high-speed sectioned photography.

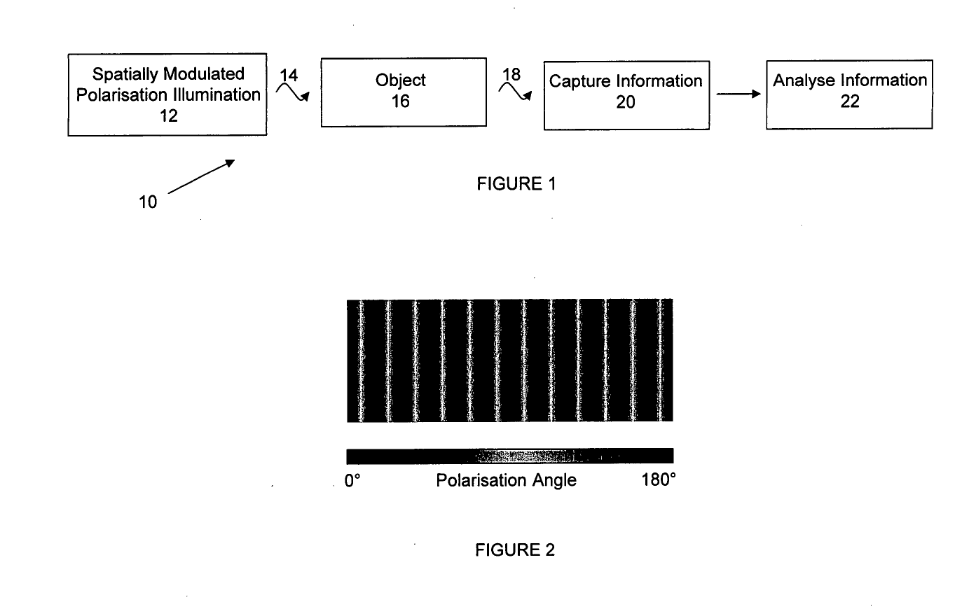

With reference to FIG. 1, a system 10 for obtaining imaging information from an object of interest 16 is provided comprising a means 12 for generating and illuminating the object 16 with first electromagnetic (EM) waves 14, and a further means 20 to capture second EM waves 18 emanating from the object in response to the first waves 14. A further means 22 may be provided to analyse the captured information and extract the desired imaging information.

At least some of the illuminating EM waves 14 are spatially modulated with respect to their polarisation. For example, in one embodiment, the illuminating EM waves 14 may be in the form of visible light as shown in FIG. 2—linearly polarised light of preferably homogenous intensity and periodically varying polarisation angle. The orientation of the polarisation rotates in linear dependence on position in relation to the object 16.

The object of interest 16 is illuminated with the light 14 comprising these, or similar polarisation properties. Light emanating from the object 16 in response to the illumination light will retain a proportion of the linear polarisation of the illumination light (for example due to a fluorophore with an anisotropic response, due to its rotational correlation time being long in comparison to its emission lifetime). For example, in one photon fluorescence, the anisotropy for randomly oriented fluorophores has a maximum value of 0.4. Often, the direction of polarization will not be changed.

The light emanating from the object is passed through regular beam splitters in order to split the light into three identical parts. These three parts are each passed through a separate polarisation analyser, the analysers being oriented at n180°/3 to the object, whereby three images Iₙ, where n=1 to 3 are captured simultaneously. As each polarisation analyser will pass different parts of the light 14 emanating from the object 16 depending on its orientation to the polarisation of the emanating light, the resultant illumination image from each polarisation analyser is equivalent to having illuminated the object with one of three separate intensity modulated light sources. These illumination images are equivalent to the three images Iₙ described in the background section [1] (except for a decreased modulation contrast), however, a sectioning capability substantially equivalent to conventional structured illumination is obtainable with one exposure, and furthermore, the capturing of imaging information representing three illumination images provides a less computationally intensive requirement for the data extraction process as less data needs to be extrapolated in order to achieve satisfactory imaging information. Also, unlike for two images, the acquisition of three images potentially allows the reconstruction of a final image without the need to extrapolate any data, leading to an increase in image quality.

These three images may then be processed and the necessary information extracted 18 for reconstructing a resultant image providing optically sectioned and/or resolution improved images as in regular SIM. As can be seen, the resultant image is produced from a single exposure. The nature of the object of interest is of less importance with respect to its stability and speed of movement. There is no longer a problem of movement between exposures as the temporal resolution of this method can be in the order of the exposure time, and thus down to the femtosecond range and beyond.

Additionally, objects that are fragile or prone to damage during known methods of image capture may be less likely to be affected. The time taken and number of exposures required to attain sufficient information may be reduced to just one exposure. Notably, this will reduce the effects of photo-bleaching on susceptible specimens. A single flash illumination and concurrent exposure, or constant illumination and a single exposure could be employed depending on the object in question. The flash response of an object can also be investigated by capturing the single exposure at a time subsequent to the moment of application of the flash illumination. It is also possible to intentionally expose the object of interest such that it gets damaged or even destroyed, but use the fact that such destruction processes often need a certain timespan which can be longer than the exposure time, thus allowing the image information to be recorded.

The first EM waves 14 having spatially modulated polarisation 12 may be generated in a number of ways as discussed below:

### Spatially Variant Polarisation Filter

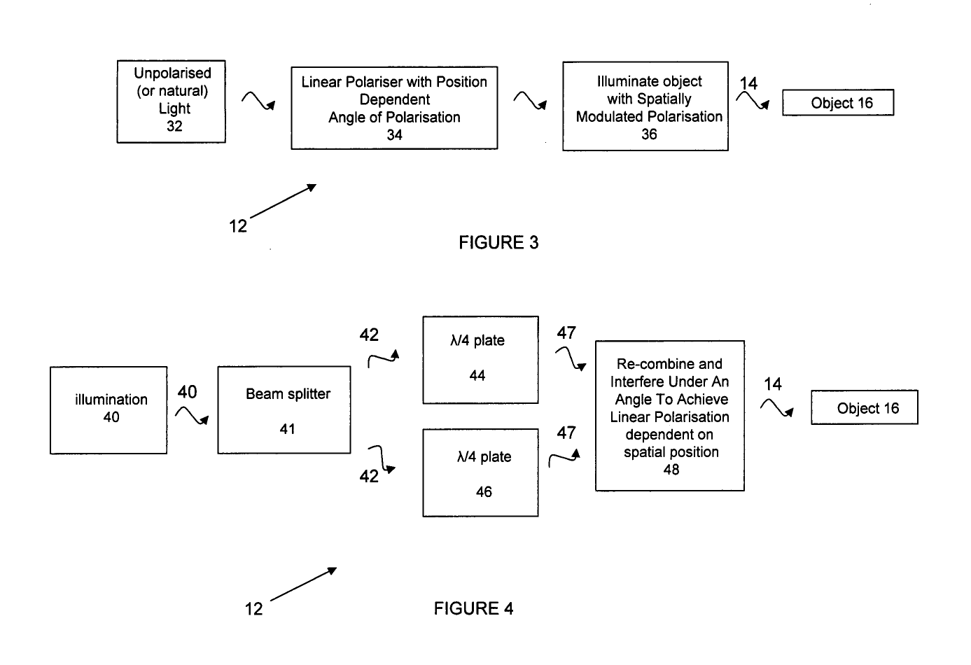

With reference to FIG. 3, in one embodiment of the imaging system, a source of unpolarised or natural light 32 is filtered by way of a spatially variant polariser 34 providing a position dependent angle of polarisation as shown in FIG. 2. After passing through filter 34, the light 14 has the polarisation properties as shown in FIG. 2. The light 14 is then projected 36 onto the object 16 in a manner known to the skilled person.

Unpolarised or natural light (such as light 32) can be written as a vector \vec{u}=(1,0,0,0). Light polarised linearly in direction a with a degree of polarisation p can be written as \vec{l}(α, p)=(1, p cos(2α), p sin(2α),0). This vector notation is known as Stokes vectors.

The first component (in this case 1) of such a vector refers to the total intensity, and the second and third components (p cos(2α), p sin(2α)) refer to the degree of polarisation (p) and the direction of the major axis direction of linear polarisation (α). The fourth component (in this case 0) describes circular polarisation.

Incoherent polarised light (such as first EM waves 14) can be described using the Mueller-matrix formalism:

In the Mueller matrix formalism, it is possible to propagate light with various polarisation properties through a particular optical setup. Components of the optical setup may be characterised by propagation matrices. A linear polariser oriented along a direction α can be written as the matrix:

$$P ( α ) = 1 / 2 ( \begin{matrix}1 & cos ( 2 α ) & sin ( 2 α ) & 0 \\ cos ( 2 α ) & {cos}^{2} ( 2 α ) & sin ( 2 α ) cos ( 2 α ) & 0 \\ sin ( 2 α ) & sin ( 2 α ) cos ( 2 α ) & {sin}^{2} ( 2 α ) & 0 \\ 0 & 0 & 0 & 0\end{matrix} ) \qquad [ A1 ]$$

The incoherent polarisation pattern \vec{L}(\vec{r}) can be written as a sheet of unpolarised light 32, \vec{s}=(δ(z),0,0,0) (where δ denotes the Dirac delta function), which is filtered by a linear polariser 34 G(\vec{r})=P(α(\vec{r})) with a linearly position-dependent orientation α(\vec{r})=\vec{k}_{G}·\vec{r}. After passing through polariser 34, the light sheet 32 has a structured or patterned polarisation corresponding to that shown in FIG. 2.

The sheet of light is then projected 36 into the object 16. This projection can be expressed as a convolution (denoted by [symbol] ) with the illumination point spread function (PSF) hᵢₗₗᵤ(\vec{r}). The illumination PSF of an optical system describes the intensity distribution inside the object (without polarisation characteristics) that is generated by a point-like light source in an image plane before the objective. It is not point-like, but rather has a spot-size that is diffraction-limited. The convolution accounts for the fact that the illumination does not only come from one point source, but rather from a whole image plane.

This projection yields:

\vec{L}(\vec{r})=[(G·\vec{s}) [symbol] hᵢₗₗᵤ](\vec{r})=(δ(z)(1, cos(2\vec{k}_{G}−\vec{r}), sin(2\vec{k}_{G}·\vec{r}),0)) [symbol] hᵢₗₗᵤ(\vec{r}), [A2]

where a convolution of a vector with h(\vec{r}) is equivalent to an independent convolution of each vector element with h(\vec{r}).

The periodicity of the modulation of the polarisation pattern may be of any period suitable for the magnification and resolution desired as is known to the skilled person. Particularly, it may be close to the Abbe frequency limit, which is of use for the emphasis on resolution improvement, close to half of this value for best Z-resolution performance, or significant lower spatial frequencies for best contrast in incoherent sectioning.

Alternatively, the polarisation pattern may comprise other patterns such as a chequerboard pattern as opposed to the stripes of FIG. 2. The polarisation pattern may alternatively be aperiodic, quasi periodic or may rotate with distance across the illuminating light beam. It is also possible to obtain information on more than three channels simultaneously, which can be required for the application of 2-dimensional patterns and for 2-dimensional resolution improvement.

### Beam Interference

With reference to FIG. 4, in another embodiment, first EM waves 14 having spatially modulated polarisation 12 are generated by way of the re-combination and interference of two beams 47 with opposing directions of circular polarisation.

In one embodiment, a source of spatially coherent linearly polarised (in this case parallel or perpendicular to the plane of the paper) illumination 40 is provided, for example but not limited to a laser. In an alternative embodiment, the source may be only partially coherent, for example but not limited to the incoherent illumination of a diffraction grating. This source 40 is split 41 into two beams 42. These two beams pass through separate λ/4 plates 44, 46. Plate 44 is +45° to the polarisation direction of beams 42 and plate 46 is −45° to the polarisation direction of the incident beams (i.e. the λ/4 plates are 90° to each other).

After passing through the λ/4 plates, one of the beams 47 possesses left-circular polarisation and the other beam 47 has right-circular polarisation as is known to the skilled person.

These two beams are re-combined 48 under an angle in order to interfere with one another inside the object 16. The angle depends on which part of the numerical aperture (NA) the beams occupy. The angle is defined as α=sin⁻¹ (NA/n) for the full NA, n being the refractive index and α the angle between beam and optical axis. This interference leads to the desired linear polarisation depending on the spatial position (first EM waves 14). Higher angles will result in higher spatial modulation frequency. Higher angles will also mean a reduction in modulation contrast, as the two beams will have axial polarisation components (pointing in the z-direction) and thus are not parallel to each other and cannot perfectly interfere.

In the case of a laser, each beam 42 is coherent alone and mutually coherent to its counterpart. If stemming from the incoherent illumination of a grating, each beam alone is incoherent, but the beams are mutually coherent to each other and able to, at least partially, interfere constructively in the sample plane.

When considering the interference in the focal plane for the coherent, paraxial case, we can write the local electric field of the individual beams 47 of orthogonal circular polarisation as:

$${{E}^{->}}_{\pm } ( {r}^{->} , t ) = \vert E \vert Re \{ \frac{1}{\sqrt{2}} ( \begin{matrix}1 \\ \pm i\end{matrix} ) exp \{ i ( \pm {{k}^{->}}_{g} {r}^{->} + ω t ) \} \} , \qquad [ A 3 ]$$

where + stands for the right circular and − for the left circular light. The term ±\vec{k}_{g}\vec{r} takes into account local phase variations stemming from the angle of incidence of the two beams. The notation of \vec{k}_{g} was chosen for consistency. The combined electric field is:

$$\begin{matrix}E ( {r}^{->} , t ) = {{E}^{->}}_{+} ( {r}^{->} , t ) + {{E}^{->}}_{-} ( {r}^{->} , t ) \\ = \vert E \vert Re \{ \sqrt{2} ( \begin{matrix}cos ( {{k}^{->}}_{g} {r}^{->} ) \\ i sin ( {{k}^{->}}_{g} {r}^{->} )\end{matrix} ) exp \{ iω t \} \} .\end{matrix} \qquad [ A4 ]$$

From equation A4 it can be seen that the angle of linear polarisation is rotating in linear dependence of \vec{r} (along the direction of \vec{k}_{g}), whereas the amplitude fluctuates in time at the frequency of the illumination light. The temporal fluctuation will normally not be measurable as it happens on a time scale much faster then any exposure time.

In the case of incoherent illumination, the above field distribution is convolved with the incoherent illumination PSF. This leads to a blurring of the previously sharply defined polarisation components. The degree of polarisation is therefore reduced, which leads to a reduced contrast in the acquired images. While this reduction in contrast is on one hand undesirable, incoherent illumination also has one advantage. The blurring is weakest in the focal plane where the coherent illumination PSF is sharpest, but stronger farther away from the focal plane. The modulation contrast, therefore, will be strongest in the focal plane and reduced away from it. As the Neil-formula [1] and other methods [5,6] detect modulation, this effect leads to an enhancement of the sectioning capability which counters the loss in contrast and reduces disturbances by the Talbot effect.

Further, with incoherent illumination, quarter-wave wide-field retarders (such as polymer-based retarders) are available which have less than 0.01λ deviation in retardance for angles of incidence up to about 30° from normal. These are more suited to incoherent illumination than conventional λ/4 plates that perform best under normal incidence.

### Birefringence

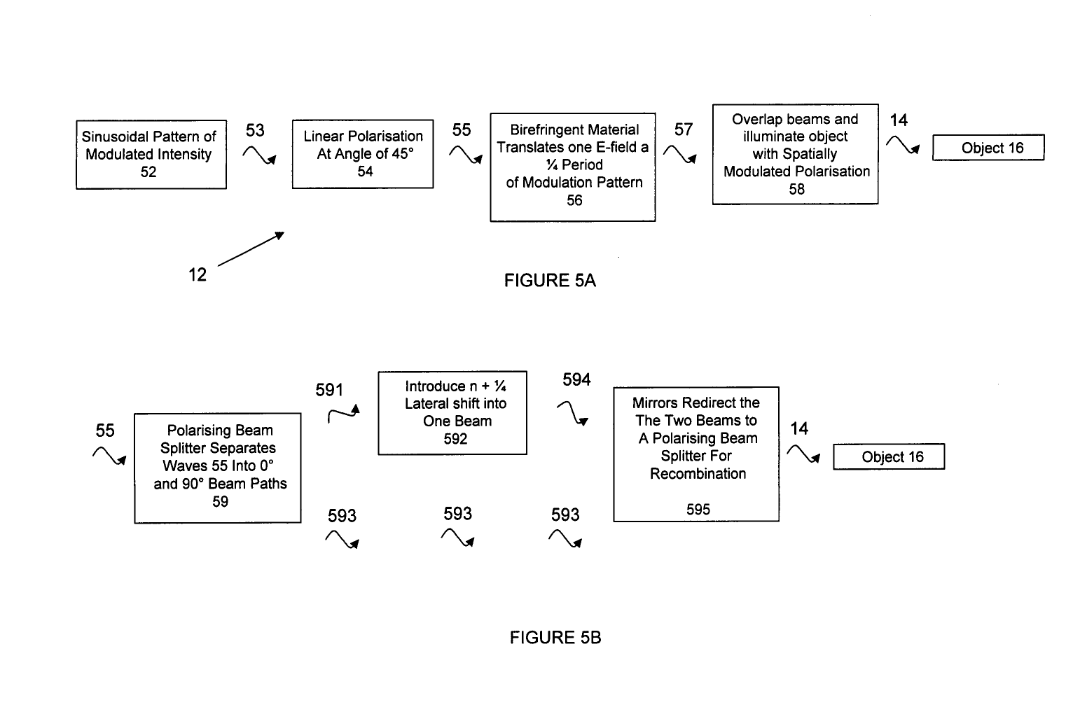

With reference to FIG. 5A, in yet another embodiment, first EM waves 14 having spatially modulated polarisation 12 are generated from an initial source 53 of a sinusoidal pattern of modulated intensity which is produced, for example, by way of passing a light beam through an intensity grating 52. The intensity modulated waves 53 are then linearly polarised 54 at an angle of 45° with respect to the principal axis of a birefringent material. The resultant waves 55 are then passed through the bi-refringent material such as, but not limited to, calcite crystal. Following passing through the calcite crystal, waves 57 are overlapped 58 with a relative lateral shift. The resulting EM waves 14 have the desired spatially modulated polarisation as will be explained below. These waves are then projected 58 on to the object 14. Note that the optics (not shown) lead to an effective shift in the image plane of the original intensity grating.

A sinusoidal pattern of modulated intensity 53 linearly polarized at an angle of 45° (54) may be represented as:

$${E}^{->} ( {r}^{->} ) = \vert E \vert ( \begin{matrix}cos ( {{k}^{->}}_{g} {r}^{->} ) \\ cos ( {{k}^{->}}_{g} {r}^{->} )\end{matrix} ) \qquad [ A5 ]$$

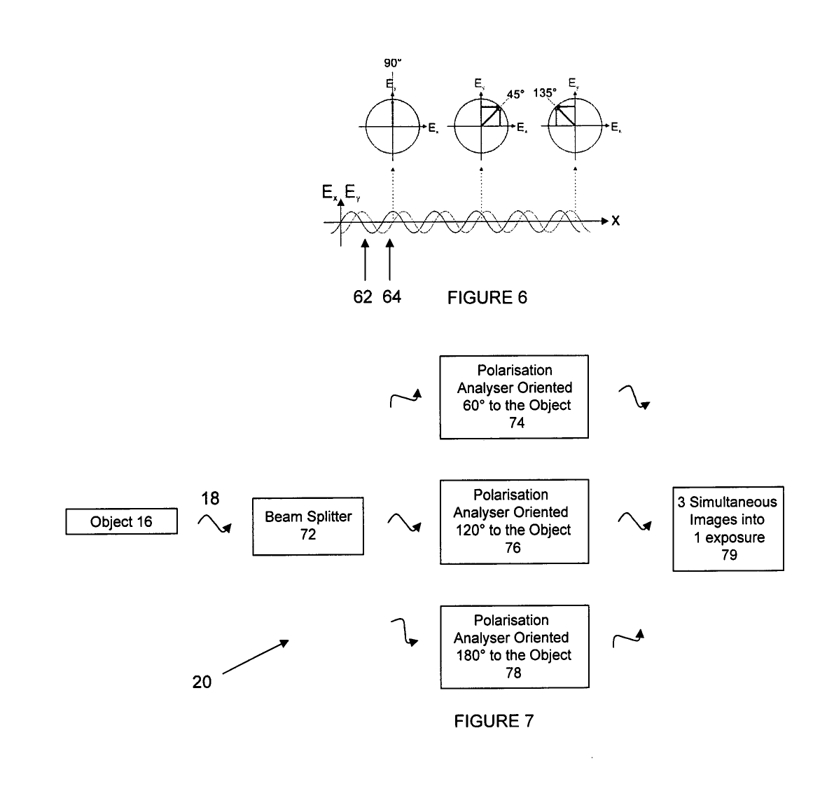

As indicated by equation A5, in a coordinate base where x corresponds to 0° and y to 90°, the waves 55 will have equally strong Eₓ and E_{y} components. A birefringent material 56, such as, but not limited to, a calcite crystal causes one of the two vector components of the electric field to undergo a spatial translation as is known to the skilled person. If this translation corresponds to a quarter period of the modulation pattern 53 (or n+¼ period, n being an integer), the shifted electric field component is described by a sine function 62 rather than a cosine 64 as can be seen in FIG. 6. The new electric field will therefore be:

$${E}^{->} ( {r}^{->} ) = \vert E \vert ( \begin{matrix}cos ( {{k}^{->}}_{g} {r}^{->} ) \\ sin ( {{k}^{->}}_{g} {r}^{->} )\end{matrix} ) , \qquad [ A6 ]$$

which corresponds to the desired spatially dependent rotation of polarisation.

A further embodiment shown in FIG. 5B, utilises an n+¼ period translation in a similar manner to the embodiment of FIG. 5A to create the desired spatially modulated illuminating polarisation pattern. In this embodiment, waves 55 are produced, for example, in the same manner as FIG. 5A. These waves 55 are polarised at an angle of 45° with respect to an axis defined by polarising beam splitter 59. Waves 55 are then passed through the polarising beam splitter 59 which splits the light into a 0° and a 90° component having separate beam paths 591 and 593. An n+¼ lateral translation is introduced 592 into one of the beams 591. The other beam 593 is unaltered. Mirrors 595 redirect the separate beams onto a second polarising beam splitter 596. This second beam splitter recombines the two beams, resulting in a spatially modulated polarization pattern as per FIG. 6. In an alternative embodiment, the mirrors 595 redirect the separate beams back on to the first beam splitter for recombination. Furthermore, the polarising beam splitter can be formed from birefringent materials, but could also use other means (for example Brewster angle) for separating the different polarisation components.

As shown in FIG. 6, when the two electric components are overlapped, the combined electric field exhibits the desired spatial modulation in polarization angle and a constant intensity.

### Linearly Polarised Light Passing Through Intensity Gratings

In another embodiment, the desired spatially polarised first EM waves 14 may be produced by way of a number of discrete light sources, for example three, each passing through an intensity grating. These light sources are individually coded with a different angle of linear polarisation. When illuminating object 16, the three different intensity patterns reproduce the spatially modulated polarisation of the previous embodiments. At any one point on the object, the three light sources will have different intensities by virtue of their respective intensity patterns from their individual intensity gratings. At various points on the object, the intensity of one of the light sources will be higher than the others, and this light source will make up the majority of the second EM waves 18 that are captured from this object point. Due to anisotropy, the second EM waves 18 retain a proportion of the incoming polarisation, therefore, when combined with all the other points on the object 16, the captured EM waves 18 possess the same spatially modulated polarisation pattern as per previous embodiments. There is also a background of unpolarised noise (due to the points on the object where the illuminating first EM waves 14 are approximately the same intensity), however sufficient information to produce an optionally sectioned image may be captured.

This technique could be used with additional light sources to give a higher resolution, however, with more than approximately ten light sources, the contrast may not be sufficient to extract the polarised response above the background noise of unpolarised light.

Furthermore, a spatial light modulator may be used to generate the intensity pattern, with the obvious advantages of the flexibility to adjust the patterns to the current object of interest. For example, the spatial size of the pattern could be made dependent on the thickness of the object to optimize the tradeoff between resolution, sectioning capability and signal to noise issues with fine patterns.

Alternatively, in other embodiments, two discrete light sources each comprising a spatial polarisation distribution and a third source with a uniform polarisation distribution could be used. Still further, at least one of the sources could comprise a spatially uniform distribution of illumination or be monochromatic.

### Capturing the Information

Turning to the means for capturing information 20, this may be achieved, for example, by way of a (multi-channel) beam splitter and subsequent computation as shown in FIG. 7 or a real-time optical process.

Firstly, turning to the mathematical description of second EM waves 18. With fluorescent microscopy, the object fluorophores absorb first EM waves 14 and emit (second) fluorescence EM waves 18. The higher the local concentration of fluorophores, and the stronger the first EM waves are, the higher the intensity of the (emitted) second EM waves will be. In order to measure the quantity of emitted intensity, the object's fluorophore density distribution ρ(\vec{r}) is multiplied with the local illumination intensity (from the first EM waves 14). Due to fluorescence anisotropy preserving some, but not all, of the incident polarisation of the first EM waves 14, the degree of polarisation of the emitted light 18 will be weaker (indicated by the factor p) than that of the illumination light 14. Hence, second EM waves 18 (at the sample) are represented by:

M(\vec{r})=(ρ(\vec{r})((δ(z)(1,p cos(2\vec{k}_{G}·\vec{r}),p sin(2\vec{k}_{G}·\vec{r}),0)) [symbol] hᵢₗₗᵤ(\vec{r})). [A7]

### Beam Splitter

With reference to FIG. 7, means 20 for capturing the second EM waves 18 emanating from the object 16 are now described. A beam splitter 72 is positioned in the optical path of second EM waves 18. In one embodiment the beam splitter creates three identical copies of EM waves 18 and feeds them into three identical polarisation analysers (74, 76, 78) positioned at, for example, n180°/3 to the object 16, whereby three illumination images Iₙ, where n=1 to 3 are captured simultaneously in one exposure by capture device 79, typically a camera. It is noted that these equidistant steps of n180°/3 are convenient for reconstruction, however, the step size may vary from beam to beam and still enable the image to be reconstructed. Alternatively, in other embodiments, the three illumination images Iₙ may be captured by three separate detectors.

To describe the imaging process 79, the emitted light distribution (EM waves) 18 is convolved with the detection PSF h_{det}(\vec{r}). Similar to the illumination PSF, the detection PSF describes the intensity distribution generated in an image plane by a single point emitter in the object 16. Hence:

$$\begin{matrix}{I}^{->} ( {r}^{->} ) = ( M ⊗ {h}_{det} ) ( {r}^{->} ) \\ = ( ρ ( {r}^{->} ) ( ( δ ( z ) ( 1 , p cos ( 2 {{k}^{->}}_{G} \cdot {r}^{->} ) , p sin ( 2 {{k}^{->}}_{G} \cdot {r}^{->} ) , 0 ) ) ⊗ {h}_{illu} ( {r}^{->} ) ) ) ⊗ \\ {h}_{det} ( {r}^{->} ) .\end{matrix} \qquad [ A8 ]$$

A polarisation analyser (74, 76, 78) oriented at an angle β individually filters the three identical beams produced by beam splitter 72 and provides positionally dependent processing of the beams. This corresponds to a multiplication with the matrix characterising a linear polariser, P(β) (see equation [A1]), which gives us the final light distribution \vec{D}_{β}(\vec{r})=P(β)\vec{I}(\vec{r}). As the light is then detected by a polarization insensitive detector (a camera 79 for capturing the fully integrated image), we are only concerned with the first component of this resulting vector, D_{β}(\vec{r})=(P(β)\vec{I}(\vec{r}))₁. We therefore only calculate that first component:

D_{β}(\vec{r})−(ρ(\vec{r})((δ(z)(1+p cos(2\vec{k}_{G}·\vec{r})cos(2β)+p sin(2\vec{k}_{G}·\vec{r})sin(2β))) [symbol] hᵢₗₗᵤ(\vec{r}))) [symbol] h_{det}(\vec{r})

D_{β}(\vec{r})=(Σ(\vec{r})((β(z)(1+p cos(2\vec{k}_{G}·\vec{r}−2β))) [symbol] hᵢₗₗᵤ(\vec{r}))) [symbol] h_{det}(\vec{r}) [A9]

The image produced [A9] is equivalent to an illumination image taken for an incoherent intensity modulated pattern, with β defining the position of that pattern. As polarisation is not conserved by anisotropy, we can expect a modulation contrast that is p times that of the contrast in the method by Neil et al [1].

Additionally, a beam splitter having x outputs where the polarisation analysers are positioned at n180°/x may be employed, where n=1 to x. This has the advantage of capturing extra information that may be used to remove imperfections in the captured EM waves 18. However, with an increased number of polarisation analysers, the number of detector elements (i.e. camera pixels) will also increase, resulting in fewer photons per pixel, which will lead to noisier images. There is a trade-off between the number of analysers for providing higher accuracy and redundancy in the information gathered, and detector noise associated with those analysers.

As an analyser will discard about half the light, in an alternative embodiment, each analyser is replaced with a polarising beam splitter. This beam splitter will split the light into one component corresponding to that transmitted by the analyser, and another orthogonal component which would have been lost in the analyser. This would double the number of images recorded in one exposure, but also the number of photons detected, having a positive rather than a negative effect on the signal to noise ratio of the captured images.

In a further alternative embodiment, the emitted light is first split into two identical beams using a non-polarising beam splitter and then each of these two beams is split using a polarizing beam splitter. The polarising beam splitters may be oriented at 45° relative to each other.

### Optical Capture

As an alternative to capturing the second EM waves 18 emanating from the object by way of a beam splitter, polarisation analysers and then computationally reconstructing a final image as per FIG. 7, the reconstruction may also be achieved optically. As described herein, the object is illuminated 14 by way of a spatially varying polarisation filter 34 and the emitted light 18 is filtered with the same or a filter of identical spatial frequency modulation. The resultant image is captured 20, and without computational reconstruction, the image exhibits optical sectioning and possible resolution improvement as per the embodiments above. The light emitted from the focal plane has a polarisation matching that of the polariser and therefore passes through the filter without much filtering. Some of the light, however, will be filtered out by the polariser because the degree of polarisation diminishes due to the anisotropy of fluorescence polarisation.

With increasing distance from the focal plane, the polarisation characteristics of the illumination light are substantially lost because of blurring caused by blurred illumination as well as detection PSFs. This results in approximately 50% of the light emanating from these parts of the sample being blocked by the sinusoidal polarisation filter. This is a substantially higher percentage of blocking than occurs with the light emanating in the focal plane.

The resulting image, therefore, will exhibit a degree of optical sectioning. However, as the out of focus light will only be reduced to approximately 50%, this optical method does not exhibit as high an optical sectioning as when beam splitters and computational reconstruction methods are employed.

This optical reconstruction, without the need for any computation, provides a purely optical, and therefore real-time, sectioning microscope. It is clear that a combination of this optical method with the aforementioned computational methods or filtering or deconvolution techniques may further increase the performance of such microscopes.

### Practical Uses

As well as optically sectioning an object such as a biological specimen as previously described above, the system and methods contained herein may also be employed in the field of underwater imaging. In a scenario where the water is too cloudy, and traditional imaging techniques are rendered unsuitable, the optical sectioning capability will allow the suppression of light coming from sections other than the section of interest. This will allow imaging despite the cloudy surroundings.

Optical sectioning may also be employed for range finding. For any given focal length, the light returning from that length will be in focus with the incident light. This phenomena may be used for range finding in that light returning from a distant object in focus will be preserved and the light that is out of focus will be discarded as discussed above. It therefore follows that a higher magnitude of returning light will be present when the focal length of the system is the same as the distance to the object of interest. By using EM waves in the radio spectrum, this range finding capability could be up-scaled.

### Practical Realisation

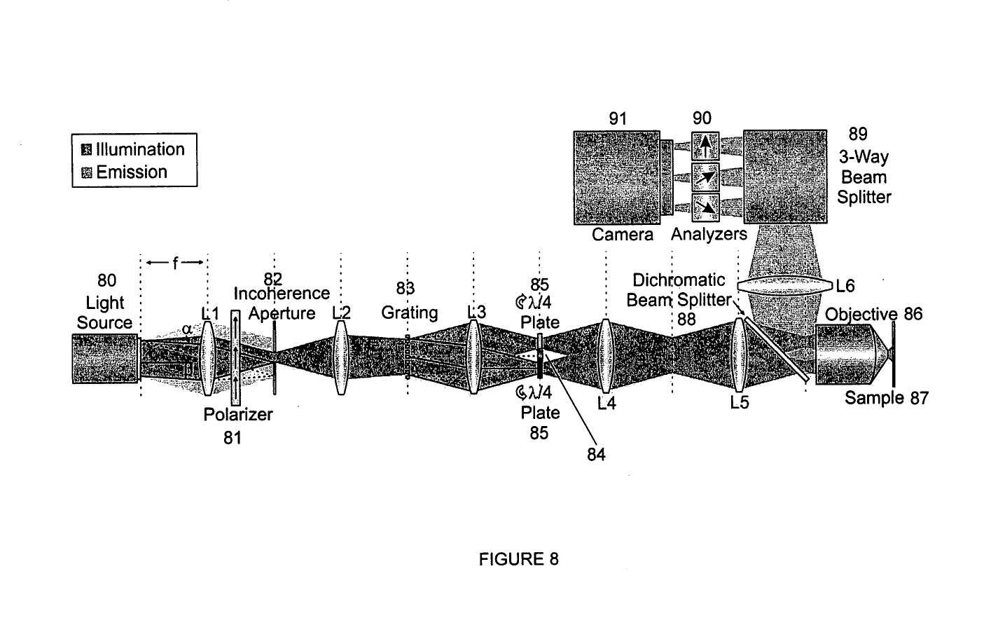

Turning to FIG. 8, a practical realisation of FIGS. 4 and 7 is illustrated. The lower light path depicts the illumination side of the system: via lens L1 of focal length f and a polarizer 81, light from source 80 is linearly polarized and illuminates an incoherence aperture 82. This aperture limits the angle of incidence for the illumination of a diffraction grating 83, which is placed in an image plane conjugate to the aperture. This limitation is exemplified for two angles α (allowed) and β (blocked). The incoherence aperture size is chosen such that the individual diffraction orders can be separated in another conjugate plane. The central zero-order is blocked by a beam stop 84, whereas the −1st order is left circularly polarized and the +1st order is right circularly polarized by means of λ/4-plates 85. Lenses L4 and L5 relay these circularly polarized orders into the back focal plane of the objective 86 and onto sample 87.

The upper light path depicts the detection side of the system: a dichromatic beam splitter 88 separates the emitted light from the illumination path. A three-way beam splitter 89 divides the light into three identical components, which are then filtered by polarization analyzers 90 oriented at three different angles (for example 0°, 60°, 120°) before they are imaged on different regions of the same CCD camera 91. These three images contain the information needed to calculate an optically sectioned image similar to those of conventional SIM.

It will be appreciated that the disclosed embodiments herein are not limited to fluorescence microscopy. It applies equally to most microscopy methods where the object conserves, in the second EM waves emanating from the object, at least a proportion of the incident polarisation. For example, but not limited to reflection and scattering microscopy. In contrast to the multi-colour illumination strategy [3] the method described here would also work for coloured and textured objects of interest.

### REFERENCES

1. Neil et al., Opt. Lett. 22, 1905-1907 (1997)
2. Heintzmann, Methods Cell Biol., 81, 561-580 (2007)
3. Krzewina et al., Opt. Lett. 31 Iss. 4, 477-479 (2006)
4. Huisken et al., Science 305, 1007-1009 (2004)
5. R. Heintzmann. Structured illumination methods. chapter 13 in: Handbook of Biological Confocal Microscopy, J. B. Pawley (ed.), Springer USA, 3rd edition, 265-279, 2006
6. R. Heintzmann and P. A. Benedetti, High-Resolution Image Reconstruction in Fluorescence Microscopy with Patterned Excitation, Applied Optics 45, 5037-5045, 2006.

1. (canceled)

2. A method of obtaining, in a single exposure, imaging information from an object representative of at least two distinct illumination images, the method comprising the steps of:
generating first electromagnetic waves at least some of which having spatially modulated polarisation;
illuminating the object with the first electromagnetic waves; and
capturing second electromagnetic waves emanating from the object.

3. The method according to claim 2 further comprising the steps of
processing the captured second electromagnetic waves; and
extracting imaging information from the processed waves.

4. The method according to claim 2 wherein the generating step comprises:
generating incoherent light and filtering the incoherent light with a spatially varying polarising filter.

5. The method according to claim 2 wherein the generating step comprises:
generating a light source;
splitting the light source into two light beams;
altering the phase delay between the two light beams such that the beams have opposing circular polarisation; and
re-combining the two light beams back together.

6. The method according to claim 5 wherein the altering step comprises passing each light beam through a separate λ/4 wave plate, one wave plate being arranged to generate left-circular polarised light, the other being arranged to generate right-circular polarised light.

7. (canceled)

8. The method according to claim 2 wherein the generating step comprises:
generating light having a sinusoidal intensity pattern;
linearly polarising the light at an angle of 45° with respect to the principal axis of a birefringent material;
passing the light through the birefringent material to produce two separate beams and re-combining the two beams back together with a relative lateral shift after they passed through the birefringent material.

9. (canceled)

10. The method according to claim 2 wherein the generating step comprises:
generating light having a sinusoidal intensity pattern;
linearly polarising the light at an angle of 45° passing the light through a polarising beam splitter to form two separate beams;
introducing a lateral shift into one of the beams; and
re-combining the two beams back together.

11. The method according to claim 2 wherein the capturing step comprises:
splitting the light emanating from the object into at least two distinct beams;
passing each beam through a polarisation analyser;
and capturing the light in one exposure with at least one capture device.

12. The method according to claim 11 wherein the polarisation analysers are positioned at n180°/x where x equals the number of distinct beams of light and n=1 to x.

13. The method according to claim 4 wherein the capturing step comprises:
filtering the light emanating from the object through the same filter or a filter of identical spatial frequency modulation; and
capturing the light in one exposure with at least one capture device.

14. The method according to claim 2 wherein at least some of the first electromagnetic waves have a spatially uniform polarisation distribution.

15-20. (canceled)

21. The method according to claim 2 wherein the spatially modulated polarisation of the first electromagnetic waves varies periodically from 0° to 180°; or wherein the spatially modulated polarization of the first electromagnetic waves varies rotationally.

22. (canceled)

23. The method according to claim 2 further comprising the step of producing an optically sectioned image from the imaging information.

24. The method according to claim 2 further comprising the step of determining the range of an object of interest from the imaging information

25. (canceled)

26. A system for obtaining, in a single exposure, imaging information from an object representative of at least two distinct illumination images, the system comprising
means arranged to generate first electromagnetic waves at least some of which having spatially modulated polarisation;
means arranged to illuminate the object with the first electromagnetic waves; and
means arranged to capture second electromagnetic waves emanating from the object

27. A system according to claim 26 further comprising:
means arranged to process the captured second electromagnetic waves; and
means arranged to extract imaging information from the processed waves.

28. The system according to claim 26 wherein the generating means comprise an incoherent light source and a spatially varying polarising filter arranged such that light from the light source is filtered by the filter.

29. The system according to claim 26 wherein the generating means comprises:
a light source;
a means arranged to split the light source into two light beams;
means arranged to alter the phase delay between the two light beams such that the beams have opposing circular polarisation; and
means arranged to re-combine the two light beams.

30. The system according to claim 29 wherein the altering means comprise two λ/4 wave plates, one wave plate being arranged to generate left-circular polarised light, the other being arranged to generate right-circular polarised light.

31. (canceled)

32. The system of claim 26 wherein the generating means comprises:
means arranged to impose a sinusoidal intensity pattern on light from a light source;
a bi-refringent material;
means arranged to linearly polarise the light at an angle of 45° with respect to the principal axis of a birefringent material; means arranged to pass the light through the birefringent material to produce two separate beams; and
means arranged to re-combine the two beams with a relative lateral shift after they have passed through the birefringent material.

33. (canceled)

34. The system according to claim 26 wherein the generating means comprises:
means arranged to generate light having a sinusoidal intensity pattern;
means arranged to linearly polarise the light at an angle of 45°;
at least one polarising beam splitter;
means for introducing a lateral shift into one of the beams; and
means for redirecting the split beams back onto one another.

35. The system according to claim 26 wherein the capturing means comprises:
means arranged to split the light emanating from the object into at least two distinct beams;
a polarisation analyser arranged to pass each beam individually; and
a device arranged to capture the light in one exposure.

36. The system according to claim 35 wherein the polarisation analysers are positioned at n180°/x where x equals the number of distinct beams of light and n=1 to x.

37. The system according to claim 28 wherein the capturing means comprises:
the same filter or a filter of identical spatial frequency modulation arranged to filter the light emanating from the object; and.
a device arranged to capture the light in one exposure.

38. The system according to claim 26 wherein at least some of the first electromagnetic waves have a spatially uniform polarisation distribution.

39-44. (canceled)

45. The system according to claim 26 wherein the spatially modulated polarisation of the first electromagnetic waves varies periodically from 0° to 180°; or wherein the spatially modulated polarization of the first electromagnetic waves varies rotationally.

46. (canceled)

47. The system according to claim 26 further arranged to produce an optically sectioned image from the imaging information.

48. The system according to claim 26 further arranged to determine the range of an object of interest from the imaging information.

49-50. (canceled)
